(19) United States
(12) Patent Application Publication
(10) Pub. No.: US 2018/0203095 A1
(43) Pub. Date: Jul. 19, 2018

(54) A METHOD AND SYSTEM OF RADAR COMMUNICATION

(71) Applicant: SHENZHEN UNIVERSITY, Shenzhen, Guangdong (CN)

(72) Inventors: Ning XIE, Shenzhen, Guangdong (CN); Baoliang LI, Shenzhen, Guangdong (CN); Li ZHANG, Shenzhen, Guangdong (CN); Hui WANG, Shenzhen, Guangdong (CN)

(73) Assignee: SHENZHEN UNIVERSITY, Shenzhen, Guangdong (CN)

(21) Appl. No.: 15/566,865

(22) PCT Filed: Sep. 18, 2017
(86) PCT No.: PCT/CN2015/090049

§ 371 Date: Apr. 4, 2018

(30) Foreign Application Priority Data
Apr. 16, 2015 (CN) 201510180509.3
Apr. 16, 2015 (CN) 201510180526.7

(51) Int. Cl. G01S 7/28; G01S 7/292

(52) U.S. Cl. CPC G01S 7/2813; G01S 7/2926; G01S 7/2927

(57) ABSTRACT

The present disclosure provides a method and system of radar communication, including functions of signal processing, transmitting, receiving, analyzing, calculation, or the like. The system may be configured to obtain a parameter relating to a target source. The system may detect a frequency band under little interference or no interference from a plurality of carrier frequencies to be selected; generate a carrier signal based on the detected frequency band, and further modulate and transmit the transmitting signal using the carrier signal.

### TECHNICAL FIELD

The present disclosure generally relates to a communication system, and more particularly, a method and system of radar communication.

### BACKGROUND

By transmitting a signal and receiving a reflected signal of a corresponding target, a system of radar communication may estimate information, such as a distance, an angle, a Doppler shift of the corresponding target. In recent years, with the increasing shortage of spectrum resources, frequency interference has become more and more serious, and because the radio spectrum has the characteristics of exclusivity and limitation and is not subject to constraints of region, temporal domain and spatial domain, wireless communication becomes susceptible to interference. Frequency interference may seriously affect quality of radar communication and performance of parameter estimation. It becomes more and more important to avoid the effect of frequency interference in the radar communication and improve the accuracy of parameter estimation by using a correct and effective method. When there is no frequency interference or the frequency interference is low, the existing radar parameter estimation algorithm may often provide a high resolution of distance estimation.

When a radar system communicates in a frequency band with frequency interference, there may be mutual interference between signals, so that distance accuracy of estimation may be not high enough, resolution is not strong, and parameter estimation performance may be poor. In addition, the number of transmitted pulses may limit the number of target sources that may be estimated to some extent. Moreover, when the number of the transmitted pulses is large, the transmitted pulses may take up large transmission bandwidth and increase the burden on the system to a certain extent. Therefore, it is desirable to design a system which may suppress the frequency interference and save the number of the transmitted pulses, so as to achieve an optimized solution of improving the performance of parameter estimation and saving the spectrum resource.

### SUMMARY

The present disclosure provides a method of transmitting a signal in a radar system, including the following steps: receiving a transmitting signal from a signal source; detecting a frequency band under little interference or no interference from a plurality of carrier frequencies to be selected; generating a carrier signal based on the detected frequency band; and modulating and transmitting the transmitting signal using the carrier signal.

According to an embodiment of the present disclosure, the transmitting signal is of Gaussian sequences, polyphase code, or space-time code

According to an embodiment of the present disclosure, the transmitted signal is orthogonal mutually or interrelated partially.

According to an embodiment of the present disclosure, the detecting the frequency band under little interference or no interference is performed via a method of spectrum sensing based on energy detection or feature detection.

The present disclosure provides a method for parameter estimation in a radar system including the following steps: receiving signals reflected from a target source; filtering the received signals using a filter corresponding to a carrier signal; converting the filtered signal downward to a baseband signal using a corresponding carrier frequency; detecting whether or not the received signals relating to each frequency band are under interference; omitting received signals under interference; expanding received signals virtually; fusing received signals under no interference and the virtually expanded received signals; and estimating a parameter relating to the target source based on the fused received signals.

According to an embodiment of the present disclosure, the detecting whether or not the received signals relating to each frequency band are under interference is determined by respectively detecting a correlation parameter between the received signals relating to each frequency band and the corresponding transmitting signals.

According to an embodiment of the present disclosure, the received signal is under no interference when the correlation parameter is larger than a threshold.

According to an embodiment of the present disclosure, the virtually expanding is performed based on received signals corresponding to two or more different carrier frequencies.

According to an embodiment of the present disclosure, the carrier frequencies after virtually expanding are linear combination of the carrier frequencies.

According to an embodiment of the present disclosure, the fusing received signals under no interference and the virtually expanded received signals is performed by linearly combining the received signals under no interference and the virtually expanded received signals.

According to an embodiment of the present disclosure, the parameter relating to the target source comprises distance, height, DOA, and relative velocity.

According to an embodiment of the present disclosure, the method for parameter estimation includes ML algorithm, APES algorithm, ESPRIT algorithm, MUSIC algorithm, AV algorithm, Capon algorithm, and GLRT algorithm.

The present disclosure provides a radar system including a receiver, receiving a transmitting signal from a signal source; selection module, detecting a frequency band under little interference or no interference from a plurality of carrier frequencies to be selected; and a transmitting link, generating a carrier signal based on the detected frequency band and modulating and transmitting the transmitting signal using the carrier signal.

According to an embodiment of the present disclosure, the transmitting signal is of Gaussian sequences, polyphase code, or space-time code

According to an embodiment of the present disclosure, the transmitted signal is orthogonal mutually or interrelated partially.

According to an embodiment of the present disclosure, the detecting the frequency band under little interference or no interference is performed via a method of spectrum sensing based on energy detection or feature detection.

The present disclosure provides a system of radar communication, including a receiver, receiving signals reflected from a target source; a receiving link, filtering the received signals using a filter corresponding to a carrier signal and converting the filtered signal downward to a baseband signal using a corresponding carrier frequency; a detection module, detecting whether or not the received signals relating to each frequency band are under interference and omitting received signals under interference; an expanding unit, expanding received signals virtually; a fusion center, fusing received signals under no interference and the virtually expanded received signals; and a calculation module, estimating a parameter relating to the target source based on the fused received signals.

According to an embodiment of the present disclosure, the detecting whether or not the received signals relating to each frequency band are under interference is determined by respectively detecting a correlation parameter between the received signals relating to each frequency band and the corresponding transmitting signals.

According to an embodiment of the present disclosure, the received signal is under no interference when the correlation parameter is larger than a threshold.

According to an embodiment of the present disclosure, the virtually expanding is performed based on received signals corresponding to two or more different carrier frequencies.

According to an embodiment of the present disclosure, the carrier frequencies after virtually expanding are linear combination of the carrier frequencies.

According to an embodiment of the present disclosure, the fusing received signals under no interference and the virtually expanded received signals is performed by linearly combining the received signals under no interference and the virtually expanded received signals.

According to an embodiment of the present disclosure, the parameter relating to the target source comprises distance, height, DOA, and relative velocity.

According to an embodiment of the present disclosure, the method for parameter estimation includes ML algorithm, APES algorithm, ESPRIT algorithm, MUSIC algorithm,

AV algorithm, Capon algorithm, and GLRT algorithm.

### BRIEF DESCRIPTION OF THE DRAWINGS

FIG. 1 shows a schematic diagram of an application scenario for the system of radar communication;

FIG. 2 is a schematic diagram of a transmitter of the system of radar communication;

FIG. 3 is a schematic diagram of a receiver of the system of radar communication;

FIG. 4 is an operational flowchart of the system of radar communication;

FIG. 5 is a flowchart of an interference detection process;

FIG. 6 is a schematic diagram of an internal structure of an analysis module;

FIG. 7 is a an operational flowchart of the analysis module;

FIG. 8 is a schematic diagram of a process for transmitting and receiving a signal by the system of radar communication;

FIG. 9 is a flowchart of a specific embodiment for an operation of the system of radar communication; and

FIGS. 10A-10E are experimental results of an specific embodiment when the system is operating.

### DETAILED DESCRIPTION

The present disclosure relates to a system of radar communication, the system of radar communication may be configured to obtain various parameters of a target source, such as but not limited to the orientation, distance, height, angle, slant distance, relative velocity of the target source, or the like. The system of radar communication may be applied to a plurality of scenarios, including but not limited to early warning, search, detection, tracking, guided command, remote control, surveillance, or the like. Particularly, the system of radar communication may be applied to fields of distance measurement and velocity measurement, including but not limited to a transportation field, an intelligent monitoring field, a precision instrument control field, maritime monitoring, air monitoring, terrain detection, or the like.

The system of radar communication of the present disclosure may obtain one or more parameters of the target source, such as orientation, distance, height, angle, slant distance, relative velocity of the target source, or the like. The system of radar communication may include a transmitter, a receiver, a transmitting antenna, a receiving antenna, an external device, or the like. The transmitter may include a controlling module, a selection module, a transmission link, or the like. The receiver may include a receiving link, a detection module, an analysis module, or the like. The transmitter may select one or more carrier frequencies to process an original signal by adding a carrier and may transmit one or more transmitted signals to the target source. The receiver may receive one or more reflected signals from one or more target sources. The receiver may also process, analyze and calculate the received signal. The analysis module of the receiver may virtually expand a real received signal corresponding to two or more different carrier frequencies at the receiver to obtain a virtual received signal corresponding to one or more transmission frequency points. This is equivalent to increasing the multiplicity of the received signal, but at the same time it is not necessary to process the original signal by adding a carrier in the transmitter by using a corresponding carrier frequency. The system may meet the accuracy of measurement results without increasing number of transmitted pulses (for example without the need to increase the system burden). When a plurality of carrier frequencies or frequency bands may be selected, the system may flexibly select carrier frequency bands and frequencies under no interference to transmit signals, select the signals under no frequency interference and expand the virtual carrier frequency signals after the signals arrive at the receiver. For example, when four carrier frequencies f1, f2, f3, f4 may process the signals by adding a carrier, it is assumed that there is interfere in two carrier frequencies thereof (such as f3 and f4), one embodiment of the present disclosure may use the carrier frequencies f1 and f2 to perform virtual expansion and to generate virtual received signals of two other carrier frequencies, so that the signals may successfully avoid interference and still have the effect of using four carrier frequencies. The system may actually reduce carrier frequencies or frequency bands required to be used, thus saving bandwidth and improving the efficiency of the bands. The system may monitor the target source that may be present around, near or within a certain distance. The monitoring process may be continuous or discontinuous. The monitoring process may be at regular time or not at regular timed. The system may transmit each parameter of the obtained target source to the external devices associated with the system in real time or non-real time, such as a remote control system, a remote server, a display device, or the like.

In order to illustrate the technical solutions related to the embodiments of the present disclosure, brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

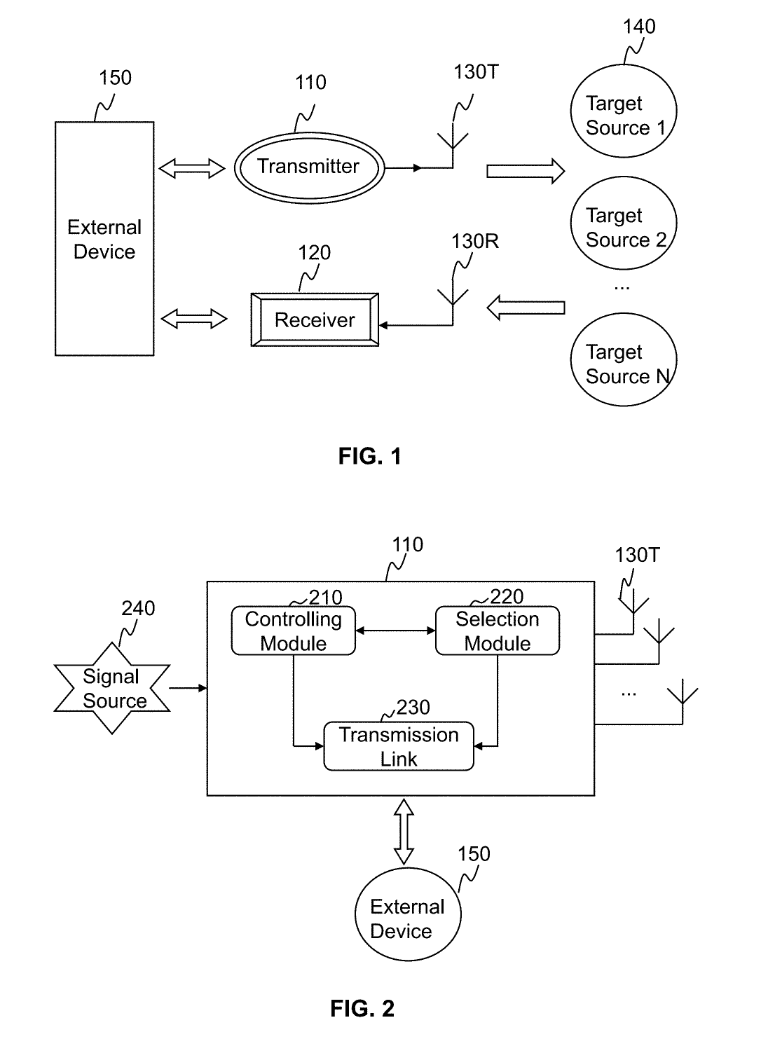

FIG. 1 shows a schematic diagram of an application scenario for a system of radar communication. The system of radar communication may include but is not limited to one or more transmitters 110, one or more receivers 120, one or more transmitting antennas 130T, one or more receiving antennas 130R, one or more target sources 140, and/or one or more external devices 150, or the like.

The transmitter 110 may perform various processing operations on an original signal, for example but not limited to conversion of signal type, conversion of signal frequency, filtering processing, modulation processing, signal amplification, or the like. The conversion of signal type may be performed through an analog-to-digital converter (Analog/Digital), and various sampling frequencies may be set in an analog-to-digital conversion process. The analog-to-digital conversion may convert an analog signal continuous in time and amplitude into a digital signal discrete in time and amplitude. The frequency conversion may include but is not limited to frequency mixing, frequency synthesis, generating a radio frequency (RF) signal, or the like. The filtering processing may include but is not limited to low pass filtering, high pass filtering, band pass filtering and band rejection filtering. The modulation processing may include but is not limited to angle modulation, phase modulation, frequency modulation, amplitude modulation, or the like. Specifically, the modulation processing may include, for example, but is not limited to rectangular amplitude modulation, linear frequency modulation, intra-pulse phase coding, rectangular frequency modulation, sinusoidal frequency modulation, phase encoding, double sideband modulation, single sideband modulation, residual sideband modulation, amplitude offset modulation, phase offset modulation, quadrature amplitude modulation, frequency offset modulation, continuous phase modulation, orthogonal frequency division multiplexing, pulse code modulation, pulse width modulation, pulse amplitude modulation, pulse position modulation, pulse density modulation, triangular integral modulation, or the like, or any combination thereof. The process of signal amplification may be performed by, for example, an RF power amplifier. The processed signal may be transmitted to the transmitting antenna 130T in real time or non-real time and transmitted by the transmitting antenna 130T in real time or non-real time. The transmission way may be a continuous wave transmission or a pulse transmission. The transmitter 110 may be configured to transmit one, one set of, and/or multiple or multiple sets of transmitted signals. When one or more signals are transmitted, the one or more signals may be transmitted in a time-sharing manner or in diversity. The transmitted signal may belong to a single frequency band or a plurality of frequency bands. The transmitted signal may be of a Gaussian sequence, a multiphase code (Frank code, P1 sequence, P2 sequence, P3 sequence and P4 sequence, etc.), or a space-time code. According to an operating frequency band, the transmitter 110 may be classified into shortwave, meter wave, decimeter wave, centimeter wave, millimeter wave, or the like. The operating frequency of the transmitter 110 may be classified into 3-30 kHz, 30-300 kHz, 0.3-3 MHz, 3-30 MHz, 30-300 MHz, 0.3-3 GHz, 3-30 GHz, 30-300 GHz, or the like. A transmitting tube that may be used by the transmitter 110 may include but is not limited to a microwave triode, a microwave tetrode, a magnetron, a klystron, a traveling wave tube, a forward wave tube, or the like. Each process or structure in the transmitter 110 described above is not necessary and is not limited to the sequential steps listed above. For persons having ordinary skills in the art, after understanding the general principle of the process of the present disclosure, without departing from the principle, may modify or change the forms or details of the particular modules, and further make simple deductions or substitutions, or may make modifications or combinations of some steps without further creative efforts. For example, the transmitter 110 may include a plurality of transmitting modules (not shown), and the plurality of transmitting modules may transmit multiple signals simultaneously or in a time-sharing manner.

The receiver 120 may be configured to receive one, a set of, and/or multiple or multiple sets of reflected signals reflected by the target source 140 through the receiving antenna 130R. The receiver 120 may receive the reflected signal in real time or non-real time. The operating frequency band of the receiver 120 may include a high frequency, an intermediate frequency and a low frequency, or the like, or any combination thereof. A circuit configuration of the receiver 120 may include but is not limited to a microwave monolithic integrated circuit (MMIC), an intermediate frequency monolithic integrated circuit (IMIC), an application specific integrated circuit (ASIC), or the like. The receiver 120 may perform the processing of the received reflected signal, including but not limited to denoising, amplification, filtering, demodulation, conversion, detection, analysis, calculation, or the like. The denoising operation may remove the clearly recognizable noise present in the received signal. The method of the amplifying operation may include but is not limited to using a high frequency amplifier, an intermediate frequency amplifier, a multi-frequency band amplifier, or the like. Methods for filtering operation may include but is not limited to using a low pass filter, a high pass filter, a band pass filter and a band rejection filter. The conversion processing may be frequency conversion, frequency synthesis, or the like. Techniques for performing the detection operation may include but is not limited to spectrum sensing techniques, and specific methods may include an energy detection algorithm, a matched filter detection algorithm, a cyclic smooth detection algorithm, or the like. The analysis and calculation methods may include but is not limited to a common mathematical operation, statistical analysis, data processing, or the like. Each process or structure in the receiver 110 described above is not essential and is not limited to the sequential steps listed above. The processes and structures of the receivers 120 described above is not necessary and not limited to the sequence and steps listed above. For persons having ordinary skills in the art, after understanding the general principle of the process of the present disclosure, without departing from the principle, may modify or change the forms or details of the particular practical ways and steps, and further make simple deductions or substitutions, or may make modifications or combinations of some steps without further creative efforts. For example, the various signal processing operations described above do not necessarily have a strict sequence, and the order of each operation step may be adjusted according to the specific needs, or one or more steps may be omitted. Further, during the signal processing, corresponding processing condition parameters may be set according to different application conditions.

The transmitting antenna 130T and the receiving antenna 130R may transmit or receive signals. The types of the transmitting antenna 130T and the receiving antenna 130R may include but is not limited to a reflector antenna and an array antenna. The reflector antenna may include but is not limited to a rotating parabolic antenna, a cutting parabolic antenna, a parabolic cylindrical antenna, a Cassegrain antenna, a single pulse antenna, a laminated beam antenna, a shaped beam antenna, a bias antenna, or the like. The array antenna may include but is not limited to a colinear array antenna, a broad-side array antenna, an end-fire array antenna, a turnstile antenna, a logarithmic dipole array antenna, or the like. The transmitting antenna 130T and the receiving antenna 130R may include but is not limited to a directional antenna, an omni-directional antenna, a smart antenna, or the like. Both the transmitting antenna 130T and the receiving antenna 130R may include a plurality of antennas. The plurality of antennas in the transmitting antennas 130T or the receiving antennas 130R may be randomly arranged around the transmitter 110 or the receiver 120, and may also surround the transmitter 110 or the receiver 120 in a certain form, including but not limited to an annular array, a butterfly array, a fan array, a linear array, a rectangular array, a circular face array, an arch array, or the like. When the antenna array is arranged, the distance between the antennas may be equal or unequal.

The target source 140 may be a single target source, a plurality of target sources randomly arranged, or a plurality of target sources arranged in accordance with a certain law. The target source 140 may also be one or more sets of target sources including the same features or similar features, for example but not limited to a set of target sources close to each other, a set of target sources with a similar height, a set of target sources with a similar angle, a set of target sources with a similar speed, or the like. The plurality of target sources 140 may be located on either side of the transmitter 110 or the receiver 120, or may be discretely distributed at any position around the transmitter 110 or the receiver 120 in a random way, or may be distributed with a combination at any position around the transmitter 110 or the receiver 120 in a random way. The distances between the plurality of target sources 140 and the transmitter 110 or the receiver 120 may be the same or different. Similarly, the height, angles, relative velocities, slope distances, or the like between the plurality of target sources 140 and the transmitter 110 or the receiver 120 may be the same or different.

The external device 150 refers to a device that is directly or indirectly related to one or more modules or components of the system of radar communication. The external device 150 may be local or remote. The external device 150 may be wired or wireless. The external device 150 may be a storage device, such as a mobile hard disk, a floppy disk, an optical disk, a random access memory (RAM), a read-only memory (ROM), a cloud disk, or the like. The device 150 may be configured to store the original signal in the signal source, and the transmitter 110 may read the original signal from the device 150 in real time or non-real time. The device 150 may also be configured to store the reflected signal received by the receiver 120. The device 150 may also be configured to store a signal processing condition parameter, a signal processing intermediate data, or the like involved in the signal processing. The external device 150 may also be a display device, such as an electronic display screen including a light emitting diode (LED), a liquid crystal display (LCD), a resistive technology touch screen, a capacitive technology touch screen, a plasma touch screen, a vector pressure sensing technology touch screen, an infrared touch screen, or the like. The device 150 may be configured to display each signal parameter of the transmitted signal or the received signal, the processing, analysis or calculation result of the transmitted or received signal, and the target source parameter calculated by the radar system. The device 150 may also be a remote control device, a remote operating system, a remote monitoring system, a database system, or the like.

The transmitter 110 and the receiver 120 may include one or more processors. Each module or unit of the transmitter 110 or the receiver 120 may be distributed in one or more processors or integrated in one or more processors. For example, the transmitter 110 may be a microprocessor. The transmitter 110 and the receiver 120 may be located in one or more microprocessors. The one or more microprocessors may communicate with a storage device (not shown), the external device 150, the transmitting antenna 130T and/or the receiving antenna 130R. The processor may read a signal from the storage device (not shown) or the external device 150 and analyze, calculate or process the read signal as described elsewhere. The one or more processors may be connected to other devices that may be directly or indirectly related to the system in a wireless or wired way. For example, the devices may include a remote control device, a remote operating system, a remote monitoring system, a database system, or the like.

It should be noted that the above descriptions about the application fields are provided for illustration purposes, and should not be designated as the only practical embodiment. For persons having ordinary skills in the art, after understanding the general principle of the radar system, without departing from the principle, may modify or change the forms or details of the particular methods and systems described above, and further make simple deductions or substitutions, or may make modifications or combinations of some steps without further creative efforts. However, those variations and modifications do not depart from the scope of the present disclosure. For example, a radar device may include the transmitter 110 and the receiver 120 at the same time. The transmitting antenna 130T and the receiving antenna 130R may be implemented by one or more transceiver antennas. The transceiver antenna may receive or transmit signals simultaneously or may switch between receiving or transmitting signals.

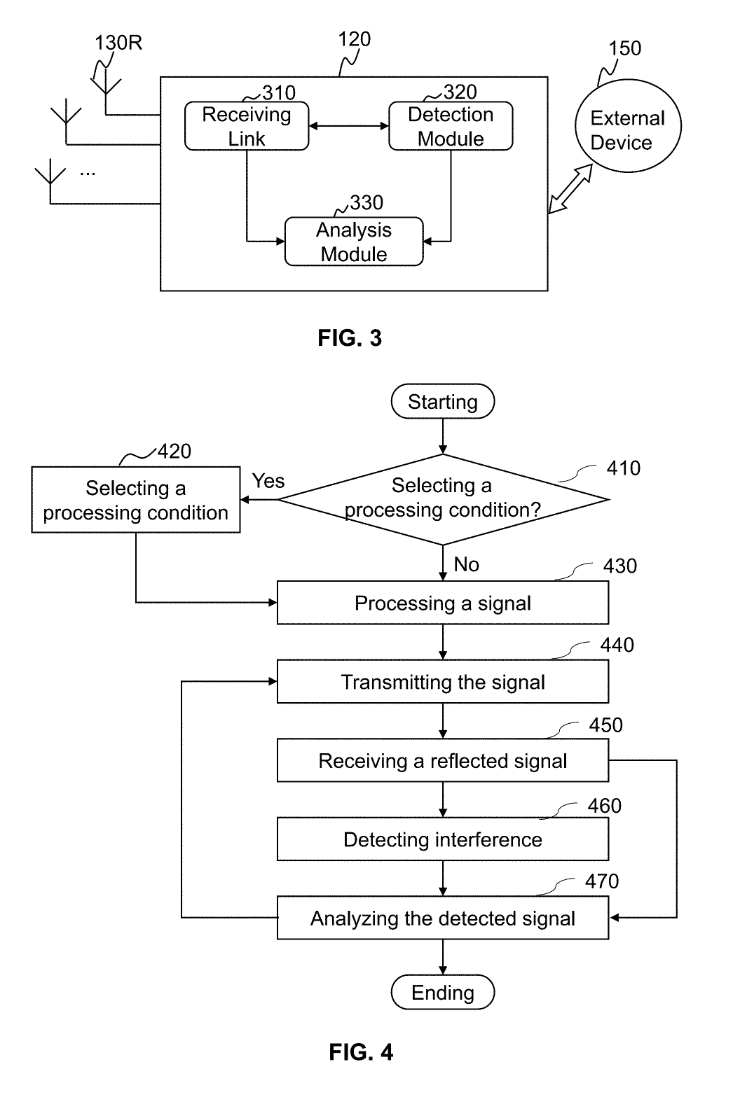

FIG. 2 is a schematic diagram of an internal structure of the transmitter 110. The transmitter 110 may include a controlling module 210, a selection module 220 and a transmission link 230. The transmitter 110 may be connected to the signal source 240, the transmitting antenna 130T and the external device 150. The controlling module 210 may be configured to implement the control of the selection module 220 and the transmission link 230 and the operational control of the transmitter 110, or the like. For example, the controlling module 210 may function as a switch, and when the controlling module 210 is switched on, the selection module 220 is enabled; when the controlling module 210 is switched off, the transmission link 230 is operated directly. Similarly, the controlling module 210 may also implement the on and off control functions of the transmitter 110, and when the controlling module 210 is switched on, the transmitter 110 is enabled; when the controlling module 210 is switched off, the receiver 120 is enabled at the time when the transmitter is switched off or after the time when the transmitter is switched off. The above description of the function of the controlling module 210 is for illustration only and does not represent that the function of the controlling module 210 is limited thereto. For example, the controlling module 210 may also be configured to control the frequency, the number and the type of the original signal which the transmission link 230 reads from the signal source 240.

The selection module 220 may be configured to obtain one or more optional signal processing conditions by detection or calculation. The selection module may be connected to the transmission link 230. The transmission link 230 may selectively read an optional processing condition from the selection module 220, perform a processing operation on the original signal, and then transmit the signal. The optional processing condition may include but is not limited to an analog-to-digital conversion (A/D) parameter, an amplification factor, a carrier frequency, a modulation mode, a modulation condition, a transmission rate, a transmission condition, or the like. The selection module 220 may obtain the optional signal processing condition by using various probe methods, detection methods and calculation and analysis methods. Various signal processing conditions may be preset according to a system parameter and may also be input from outside. Corresponding storage units (not shown) may be integrated in the selection module 220 for storing the signal processing condition. Corresponding control units (not shown) may be integrated in the selection module 220 for controlling the obtaining and reading of the signal processing conditions. The above description of the selection module 220 is for illustration only and does not represent that the function of the selection module 220 is limited thereto. For example, controlling the obtaining and reading of the signal processing conditions may also be performed by the controlling module 210. The selection module 220 may also selectively set different signal processing conditions according to a signal type in the signal source 240.

The transmission link 230 may read the original signal from the signal source 240 and perform processing operation on the original signal. The signal source 240 may include various signal types, for example but not limited to an analog signal and a digital signal. The type of the digital signal may be, for example but not limited to a Gaussian sequence signal, a polyphase code signal, or the like. The transmission link 230 may read the original signal from the signal source 240 in real time or non-real time. The transmission link 230 may process the read original signal in real time or non-real time. The processing the signal by the transmission link 230 may include but is not limited to conversion of signal type, conversion of signal frequency, filtering processing, modulation processing, signal amplification, or the like. The conversion of signal type may be analog to digital conversion (Analog/Digital) and may be implemented through the Analog/Digital converter. The conversion of signal frequency may be implemented through an oscillator, a frequency synthesizer, or the like. The filtering processing may include but is not limited to a low pass filter, a high pass filter, a band pass filter and a band rejection filter. The modulation processing may include but is not limited to angle modulation, phase modulation, frequency modulation, amplitude modulation, or the like. Specifically, the modulation processing may include, for example, but not limited to, rectangular amplitude modulation, linear frequency modulation, intra-pulse phase coding, rectangular frequency modulation, sinusoidal frequency modulation, phase encoding, double sideband modulation, single sideband modulation, residual sideband modulation, amplitude offset modulation, phase offset modulation, quadrature amplitude modulation, frequency offset modulation, continuous phase modulation, orthogonal frequency division multiplexing, pulse code modulation, pulse width modulation, pulse amplitude modulation, pulse position modulation, pulse density modulation, triangular integral modulation, or the like, or any combination thereof. The signal amplification may include but is not limited to a single channel amplifier, a multi-frequency band amplifier, a multi-band amplifier, or the like. After the operations, such as conversion, amplification, filtering, modulation, the signal may be transmitted to the transmitting antenna 130T to be transmitted. The transmitting antenna 130T may transmit the processed signal in real time or non-real time. The transmitting antenna 130T may transmit a plurality of signals simultaneously and may continuously transmit a plurality of signals in a time-sharing manner. The transmitting antenna 130T may transmit any number of signals to any direction around the transmitter 110. For example, in a Multiple-Input Multiple-Output (MIMO) radar system, signal waveforms transmitted by the transmitting antenna 130T may be mutually orthogonal or partially related.

Each of the modules in the transmitter 110 may be integrated in any combination and implement the functionality of more than one module through the same device. The above description of the transmitter 110 is merely a specific example and should not be taken as the only practical embodiment. Each of the modules or units may be implemented through one or more parts and the function of each of the modules or units is not limited thereto. For persons having ordinary skills in the art, after understanding the general principle of transmitting signals and processing signals, without departing from the principle, may modify or change the forms or details of the particular modules or units, and further make simple deductions or substitutions, or may make modifications or combinations of some steps without further creative efforts. However, those variations and modifications do not depart from the scope of the present disclosure. For example, the selection module 220 is not necessary and the transmission link 230 may not necessarily read the processing conditions from the selection module 220, and may perform converting, amplifying, modulating, filtering on the original signal according to a default value of the system or a default value of the transmission link. Specifically, for example, the transmission link 230 may process the original signal by adding a carrier using the system default carrier frequency directly, and carrier frequency data may not necessarily read from the selection module 220. In addition, a corresponding storage module (not shown) may be integrated in the transmitter 110, and the storage module (not shown) may be configured to implement the storage or caching of the signal. Alternatively, the storage module (not shown) may be integrated in the selection module 220 to store various signal processing conditions. Similarly, a corresponding storage module or unit (not shown) may be integrated in each module or unit of the transmitter 110.

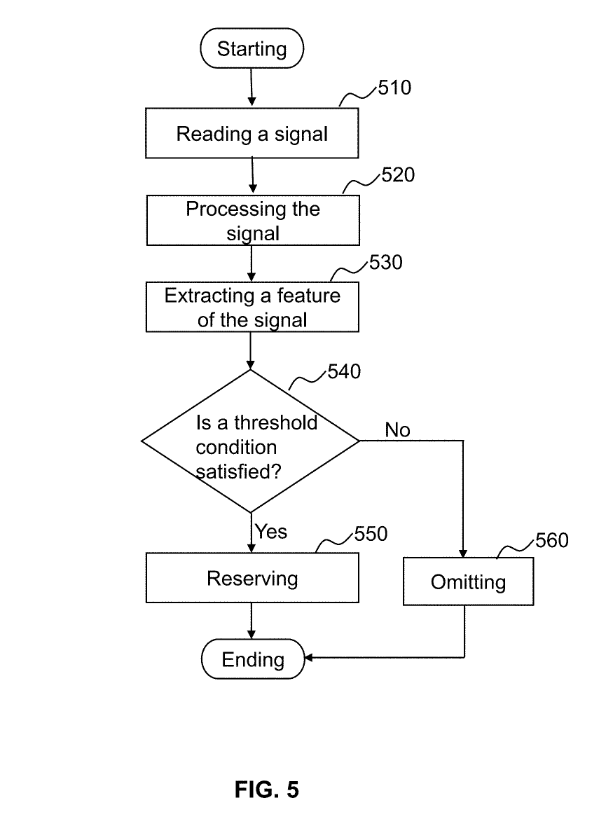

FIG. 3 is a schematic diagram of the internal structure of the receiver 120. The receiver 120 may include a receiving link 310, a detection module 320 and an analysis module 330. The receiver 120 is connected to a receiving antenna 130R and an external device 150. The receiving antenna 130R may receive a signal reflected by the target source 140. The receiving link 310 may be configured to preprocess the signal reflected by the target source 140. The preprocessing may include but is not limited to noise removal, interference removal, signal amplification, or the like. Noise removal and interference removal may remove the clearly recognizable noise present in the received signal. The signal amplification may include but is not limited to a single channel amplifier, a multi-frequency band amplifier, a multi-band amplifier, or the like. In addition, the receiving link 310 may also perform filtering processing, frequency conversion, frequency synthesis, or the like, on the received signal. The filtering may include but is not limited to a low pass filter, a high pass filter, a band pass filter and a band rejection filter. The process of frequency conversion and frequency synthesis may include frequency converting the signal by an oscillator, or further converting the signal into a baseband signal by using a frequency synthesizer, or the like. It should be noted that operations, such as filtering processing, frequency conversion and frequency synthesis may be performed by the detection module 320. The receiving link 310 may further include devices, such as a receiver protector (not shown) and a frequency mixer (not shown).

The detection module 320 may be configured to perform interference detection on the received signal. After the receiving link 310 performs a series of preprocessing operations on the received signal, the receiving link 310 may transmit the received signal to the detection module 320. The detection module 320 may detect interference frequency points or interference bands that may be present in the received signal. Detection methods may include but is not limited to spectrum sensing techniques, and specific methods may include an energy detection algorithm, a matched filter detection algorithm, a cyclic smooth detection algorithm, or the like. The detection process may include but is not limited to processing, calculation, judgment, or the like. The processing procedure may include but is not limited to a filtering processing, a frequency conversion, a frequency synthesis, or the like, and the filtering processing may include but is not limited to a low pass filter, a high pass filter, a band pass filter and a band rejection filter. The filtering processing, the frequency conversion and the frequency synthesis may also be performed in the receiving link 310. The calculation process may include but is not limited to a common mathematical operation, a scan processing based on a reference signal, extraction of a signal feature, or the like. The signal feature may be time delay, a correlation coefficient, a peak, a frequency, a period, a phase, a Signal-Noise Rate (SNR), a Bit Error Rate (BER), Signal/Interference (S/I), or the like. Particularly, the reference signal may be a transmitted signal. Particularly, the signal feature may be a correlation coefficient between the signal to be processed and the transmitted signal. The judgment process may include comparing the signal feature with the preset threshold value to perform a judgement, and detecting the possible interference frequency point or interference band based on the comparison result. The detection module 320 may transmit the detection result to the receiving link 310, and the receiving link 310 may selectively reserve the frequency point or the frequency band in the received signal according to the detection result and transmit the frequency point or the frequency band to the analysis module 330 for further analyzing and processing. The detection module 320 may also transmit the detection result to the analysis module 330, and the analysis module 330 may perform further analyzing and processing according to the detection result.

The analysis module 330 may be configured to analyze and calculate the received signal. The analysis and calculation methods may include but is not limited to a common mathematical operation, statistical analysis, data processing, or the like. The analysis and calculation methods may be a direct mathematical operation, an estimation based on an empirical value, and a programming analysis based on software. Data forms involved in the analysis and calculation processes may be specific numerical values, abstract mathematical expressions, and relation information between data. The intermediate data generated during the analysis and calculation processes may be used as initial or intermediate data for other processes. The calculation results of the module 330 may include but is not limited to orientation, distance, height, angle, relative velocity, Direction of Arrival (DOA), or the like of the target source, or a combination thereof. Each process in the analysis module 330 described above is not necessary and is not limited to the sequential steps listed above. For persons having ordinary skills in the art, after understanding the general principle of the process of the present disclosure, without departing from the principle, may modify or change the forms or details of the particular modules, and further make simple deductions or substitutions, or may make modifications or combinations of some steps without further creative efforts. Each process may be arbitrarily permutated and combined, a process may be added or omitted as needed, and such modifications and changes are within the scope of the claims of the present disclosure. For example, in the analysis or calculation process, the same analysis method or the same calculation method may be used, and two or more analysis methods or calculation methods may be used simultaneously. For example, two or more analysis methods or calculation methods may be used for the same signal, and the results are averaged by comparing the analysis results or calculation results of different methods. Alternatively, a certain analysis result or a certain calculation result is used as a reference to validate the rationality of other analysis or calculation results. A caching step may be added in the analysis or calculation process for storing real time or non-real time data involved in the operational process of the analysis module 330.

It should be noted that the above descriptions of the receiver 120 are provided for illustration purposes, and should not be designated as the only practical embodiment. Each of the modules or units may be implemented through one or more parts and the function of each of the modules or units is not limited thereto. For persons having ordinary skills in the art, after understanding the general principle of receiving signals and processing signals, without departing from the principle, may modify or change the forms or details of the particular modules and units, and further make simple deductions or substitutions, or may make modifications or combinations of some steps without further creative efforts. However, those variations and modifications do not depart from the scope of the present disclosure. For example, each of the modules in the receiver 120 may be integrated in any combination and perform the functionality of more than one module through the same device. The detection module 320 may be omitted and the signal reflected by the target source may be received and processed by the receiving link 310 and transmitted directly to the analysis module 330 for further analyzing and processing. The receiving link 310 may receive a plurality of reflected signals simultaneously and may continuously receive a plurality of signals in a time-sharing manner. A corresponding storage module (not shown) may be integrated in the receiver 120 for storing the received signal or storing real time data or any intermediate data generated in the receiver signal processing procedure.

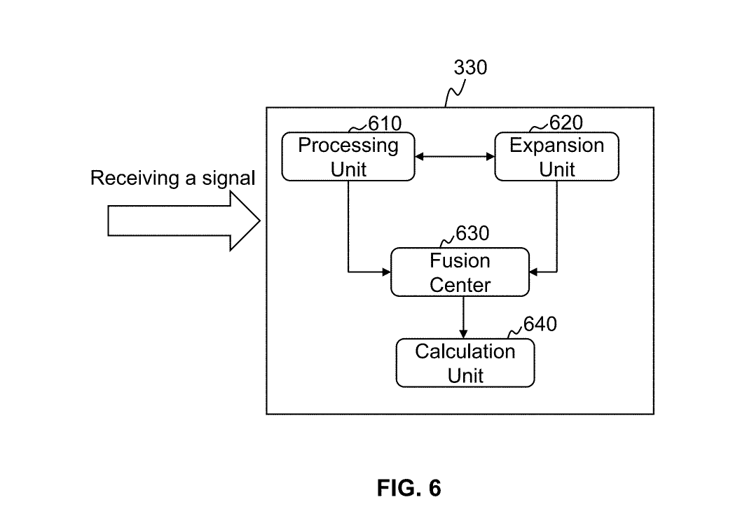

FIG. 4 is an operational flowchart of the system of radar communication. The system operating process may include the following steps: first, selection/judgment step 410 may be performed to determine whether or not to select a processing condition. The selection/judgment step 410 may be performed by the selection module 220. If it is selected that the processing condition selection is performed, 420 is performed to selectively read one or more from the currently selective processing conditions. The currently selective processing conditions may be stored in the selection module 220, the storage device (not shown) of the system, or the storage device (not shown) integrated in the selection module 220. Then, according to the processing condition currently being read, 430 is performed to correspondingly process the original signal. If it is selected in 420 that the processing condition selection is not performed, 430 is performed directly to process the original signal according to the existing or default processing conditions of the system. Particularly, one or more carrier frequencies may be configured to process the original signal by adding a carrier. Signal processing step 430 may be performed by the transmission link 230. The original signal after processing is transmitted in 440. The process of transmitting the signal may be performed by the transmitting antenna 130T. The transmitted signal may arrive at one or more target sources 140 and may be reflected by the target source 140 and return a corresponding reflected signal. The reflected signal may be received in 450. The reflected signal may be received by the receiving antenna 130R and transmitted to the receiver 120. After the receiver 120 receives the reflected signal, a series of preprocessing steps (not shown), including but not limited to noise removal, interference removal, signal amplification, may be performed on the signal. After a series of preprocessing is performed on the reflected signal, interference detection step 460 may be performed. 460 may be performed by the detection module 320. 460 may include but is not limited to processing, calculation, judgment, or the like. The processing may include but is not limited to filtering processing, frequency conversion, frequency synthesis, or the like. The filtering processing may include but is not limited to a low pass filter, a high pass filter, a band pass filter and a band rejection filter. The process of frequency conversion and frequency synthesis may include performing frequency conversion on the signal by an oscillator, or further converting the signal into a baseband signal by using a frequency synthesizer, or the like. It should be noted that filtering processing, frequency conversion and frequency synthesis may also be performed by the receiving link 310. The calculation process may include but is not limited to a common mathematical operation, a scan processing based on a reference signal, extraction of a signal feature, or the like. The signal feature may include time delay, a correlation coefficient, a peak, a frequency, a period, a phase, or the like. The judgment process may include comparing the signal feature with the preset threshold value, and detecting the possible interference frequency point or interference band based on the comparison result. The interference frequency point or the frequency band detected in 460 may be omitted, and the frequency point or frequency band satisfying the threshold condition is reserved. 460 may be performed cyclically until detecting the frequency point or frequency band of the received signal is finished. After the interference detection, a portion of the received signal containing the reserved frequency point or frequency band may be operated by the analyzing step 470. In 470, operations of analysis, calculation, or the like may be performed on the received signal. The analysis and calculation results may include but is not limited to one or more of the orientation, distance, height, angle, relative velocity, DOA, or the like of the target source, or a combination thereof. After finishing the signal analysis step, the process may return to 440 to continue transmitting a new signal and start a new process. The methods and steps described herein may occur in any suitable order in an appropriate situation or may be performed simultaneously. In addition, the individual steps may be omitted from any of the methods without departing from the spirit and scope of the subject matter described herein. Each aspect of any of the examples described above may be combined with each aspect of any of the other examples described to form a further example without losing the sought effect. For example, processing condition selection 420 is not necessary, and the processing conditions stored in the system may be randomly read when the original signal is processed and not necessarily read from the selection module 220. Further, the interference detection step 460 is not necessary, and if the frequency point or frequency band not subject to interference has been selected as the processing condition when the signal is transmitted, the interference detection step may be omitted after the reflected signal is received. A storage step (not shown) may be added between 450 and 460 and may be configured to store the received signal, so that 460 may be performed in real time or non-real time. Similarly, a corresponding storage step may be added between any two steps.

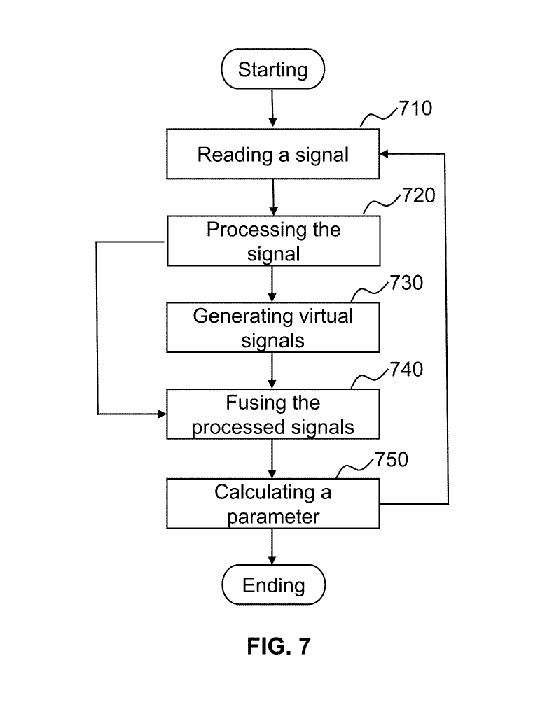

FIG. 5 is a flowchart of an interference detection process. The interference detection may detect possible interference frequency point in the received signal. The interference detection process may include the following steps: first, one or more signals is read in 510, the process of reading the signal may be performed through the receiving link 310, or may be performed through the detection module 320. Processing operations may be performed on the one or more read signals in 520, the processing operations may include but is not limited to amplification, noise removal, interference removal, filtering processing, frequency conversion, frequency synthesis, or the like. Methods involved in the processing process may include but is not limited to mathematical calculation, statistical analysis, analog simulation, or the like. Examples thereof may include but is not limited to, for example, wavelet transformation, support vector machine (SVM), Fourier transformation, sine transform, cosine transform, Walsh transformation, high pass filtering, low pass filtering, band pass filtering, Wiener filtering, Kalman filtering, linear filtering, nonlinear filtering, adaptive filtering, or the like. Processing signal step 520 may be implemented through the transmission link 310, may also be implemented through the detection module 320, or may be implemented through both. The process of processing the signal may be real time, or may also be non-real time. The extraction of signal feature may be performed on the processed signal in 530. Signal features may include but is not limited to time delay, a correlation coefficient, a peak, a frequency, a period, a phase, or the like. The time delay may be time delay of a signal to be detected with respect to the transmitted signal. The correlation coefficient may refer to correlation of the signal to be detected with respect to the transmitted signal. Methods of extraction of signal feature may include but is not limited to a linear function method, a logarithmic function method, an arc-cotangent function method, a norm method, a historical threshold iteration, a modeling method, a least squares method, an elimination method, an order-reduction method, a substitution method, an image method, a comparative method, a scale method, a vector method, an induction method, an reduction method, an exhaustive method, a method of completing the square, an undetermined coefficient method, a method of element changing, a dismantling polynomial method, a complementary polynomial method, a factorization method, a parallel translation method, a function approximation method, an interpolation method, a curve-fitting method, an integration method, a differential method, a perturbation method, or the like, or a combination thereof. After obtaining the signal features by extraction, judgment step 540 is performed. In 540, a threshold of feature value may be set, and threshold judgment is performed on the extracted feature value of the obtained signal. If a threshold condition is satisfied (for example, the feature value is larger than the set threshold), the signal (or the carrier frequency point corresponding to the signal) is reserved. If the threshold condition is not satisfied (for example, the feature value is smaller than the set threshold), the signal (or the carrier frequency point corresponding to the signal) is omitted. The methods and steps described herein may occur in any suitable order in an appropriate situation or may be performed simultaneously. In addition, an individual step may be removed from any of the methods without departing from the spirit and scope of the subject matter described herein. Each aspect of any of the examples described above may be combined with various aspects of any of the other examples described to form a further example without losing the sought effects. For example, a cache step (not shown) may be added between 510 and 520 to cache the read signal and read by 520 in real time or non-real time. Similarly, a corresponding storage step may be added between any two steps. 530 and 540 may be performed simultaneously, and feature extraction and threshold judgment may be performed on each received signal until each received signal has been detected.

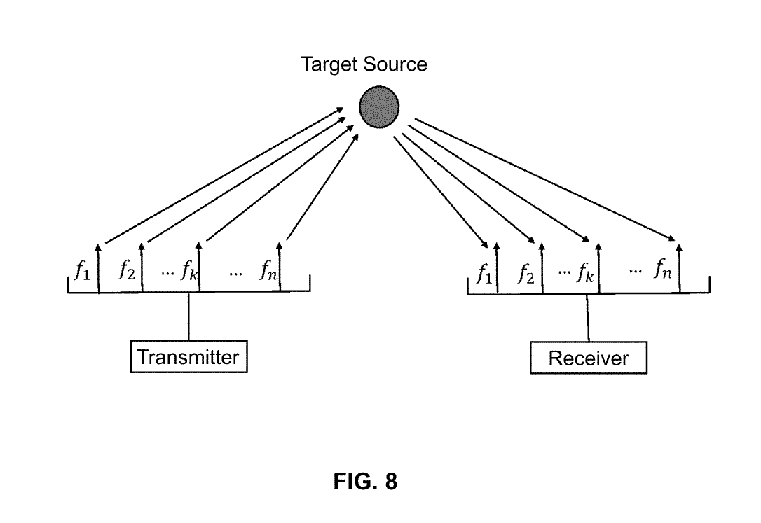

FIG. 6 is a schematic diagram of an internal structure of a specific embodiment of the analysis module. The analysis module 330 may include a processing unit 610, an expansion unit 620, a fusion center 630 and a calculation unit 640. The analysis module 330 may receive a signal transmitted by the receiving link 310, may also receive a signal detected by the detection module 320. The process of receiving the signal may be real time, or may also be non-real time. The processing unit 610 may be configured to process the received signal. The processing process may be real time, may also be non-real time. The processing unit 610 may obtain one or more signal processing results by calculation or processing. The signal processing result may include a channel coefficient, a carrier frequency (carrier frequency point), a reflection coefficient, an inter-frequency interference coefficient, a noise signal, a target delay, or the like, or a combination. The processing unit 610 may process and analyze the received signal if the receiving link 310 receives only a signal of a carrier frequency. If there are two or more signals, the expansion unit 620 may obtain two or more expansion coefficients according to two or more signal processing results of the processing unit 610, and then expand two or more received signals to generate one or more virtual received signals. The expansion way may be determined based on a system preset rule, or may be determined according to a mathematical relationship between the selected plurality of received signals, or may be determined according to a mathematical association between the two or more signal processing results. In particular, a mathematical relationship between a plurality of carrier frequencies in the received signals may be calculated, and a corresponding function expression may be deduced or fitted, so as to calculate one or more expansion coefficients that satisfy the corresponding function expression and thus fit a series of virtual received signals that satisfy a corresponding mathematical relationship. The process of generating the virtual received signals may be a mathematical derivation process or an analog simulation process. Specifically, for example, according to one or more expansion coefficients, generation of a corresponding carrier frequency may be simulated and transmission and reception of an analog signal may be simulated. And a process of processing transmitted signals by adding a carrier and a process of processing the received signals by the receiving link 310 are further simulated so as to obtain one or more virtual received signals obtained by analog simulation. The fusion center 630 may be configured to fuse the existing received signals and the virtual received signals obtained through virtual expansion. The signal fusion process of the fusion center 630 may include various simulating calculations including but not limited to physical simulation, mathematical simulation, semi-physical simulation, continuous simulation, discrete simulation, analog simulation, digital simulation, hybrid simulation, real-time simulation, super real-time simulation, sub real-time simulation, or the like, or a combination thereof. Preferably, the signal fusion process of the fusion center 630 may include the following steps: extracting signals of different carrier frequencies and performing virtual frequency expansion using a portion of the signals of the carrier frequencies. Position information of the target source in the radar system, including but not limited to orientation, distance, height, angle, slant range, relative velocity, DOA, or the like, or a combination thereof, may be estimated and extracted by using a real received signal and the virtual received signals obtained by virtual expansion. Mathematical calculation, discrete signal real-time processing, or the like are included thereof.

The calculation unit 640 may be configured to calculate various parameters of the target source 140, for example, but not limited to, the orientation, the distance, the height, the angle, the slant range, the relative velocity, the DOA of the target source, or the like, or a combination thereof. The calculation unit 640 may adopt one or more algorithms such as a Maximum-Likelihood (ML) algorithm, a Amplitude Phase Estimation (APES) algorithm, an Estimation of Signal Parameters by Rotational Invariance Techniques (ESPRIT), a Multiple Signal Classification (MUSIC) algorithm, an Auxiliary Vector (AV) algorithm, a Capon algorithm, a Generalized-Likelihood Ratio Test (GLRT) algorithm to estimate different parameters of the target source. Mathematics calculation methods involved in the calculation process may include but is not limited to a linear function method, a logarithmic function method, an arc-cotangent function method, a norm method, a historical threshold iteration, a modeling method, a least squares method, an elimination method, an order-reduction method, a substitution method, an image method, a comparative method, a scale method, a vector method, an induction method, an reduction method, an exhaustive method, a method of completing the square, an undetermined coefficient method, a method of element changing, a dismantling polynomial method, a complementary polynomial method, a factorization method, a parallel translation method, a function approximation method, an interpolation method, a curve-fitting method, an integration method, a differential method, a perturbation method, or the like, or a combination thereof.

It should be noted that the above descriptions of the analysis module 330 are provided for illustration purposes, and should not be designated as the only practical embodiment. Each of the modules or units may be implemented through one or more parts and the function of each of the modules or units is not limited thereto. For persons having ordinary skills in the art, after understanding the general principle of receiving signals and processing signals, without departing from the principle, may modify or change the forms or details of the analysis module, and further make simple deductions or substitutions, or may make modifications or combinations of some steps without further creative efforts. However, those variations and modifications do not depart from the scope of the present disclosure. For example, the units in the analysis module 330 may not necessarily exist separately, and the units may be integrated in one or more processors or other devices that may implement the functions of one or more units. In addition, the expansion unit 620 may be not necessary, if the processing of the signal is sufficiently detailed when the signal is transmitted, or the processing conditions that the transmitter may select are sufficient, that is, if the number and expression of the received signal are sufficient to satisfy the preset accuracy of the system, the process of expanding the virtual received signal may be not necessary. In addition, corresponding storage units (not shown) may be integrated in the analysis module 330 for storing the analysis or processing results during the signal analysis process or for storing the received signal. Similarly, storage subunits (not shown) may also be integrated in each unit respectively.

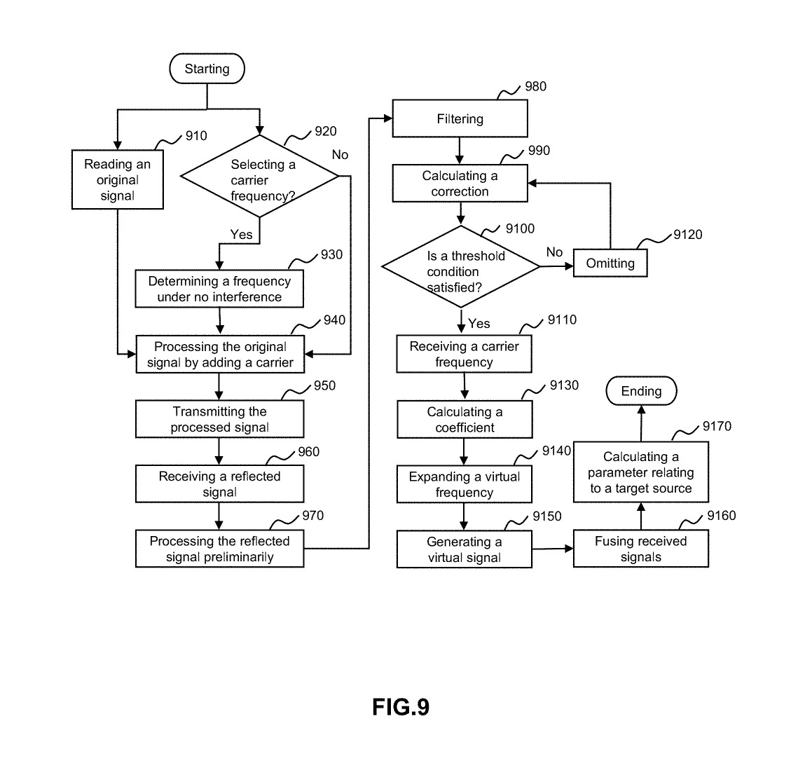

FIG. 7 is a flowchart of a specific embodiment of a running process of the analysis module 330. The operation process of the analysis module 330 may include the following steps: first, a signal is read in 710, and the read signal may be transmitted directly to a processing step 720 in real time or be transmitted to the processing 720 through a cache step (not shown). The read signal may be subject to a series of signal processing operations in 720, the processing ways may include but is not limited to various arithmetical operations, for example, include but not limited to a linear function method, a logarithmic function method, an arc-cotangent function method, a norm method, a historical threshold iteration, a modeling method, a least squares method, an elimination method, an order-reduction method, a substitution method, an image method, a comparative method, a scale method, a vector method, an induction method, an reduction method, an exhaustive method, a method of completing the square, an undetermined coefficient method, a method of element changing, a dismantling polynomial method, a complementary polynomial method, a factorization method, a parallel translation method, a function approximation method, an interpolation method, a curve-fitting method, an integration method, a differential method, a perturbation method, or the like, or a combination thereof. The signal processing result may include a channel coefficient, a carrier frequency (carrier frequency point), a reflection coefficient, an inter-frequency interference coefficient, a noise signal, a target delay, or the like, or a combination thereof. In particular, the processing process may perform a scan process on a signal to be processed received through the analysis module 330 by using the transmitted signal. The delay time r of each target source may be estimated by the scan process, and the portion of the received signal relating to each target source based on each carrier frequency may be derived according to value of the delay time. And the signal features such as the channel coefficient in each portion of the received signal are further derived. After the processing step 720, a series of signal processing results of the read signal may be obtained. The 730 may be performed in real-time or non-real time, the step may generate one or more virtual received signals according to the obtained signal processing results and read received signals. In the process of generating the virtual received signals, various data may be read in real-time or non-real time, including but not limited to intermediate data or final data in the process of processing the signals in 720, the received signal read in 710, other data relating to the processing of reading the signals, and related data stored in the system. The process of generating the virtual received signals in 730 may be performed by the expansion unit 520. The generated one or more virtual received signals may be transmitted to 740 in real time or non-real time. In 740, the read received signal and the virtual received signals may be fused into one or more new received signals. The process of fusing the signals may be real time, or may also be non-real time. The signal that may be read or selected in the fusing process may be a signal processed in 720 or may be a virtual received signal generated in 730. The new received signal may be fused by any two, three, four, multiple, and/or one or more sets of signals in these signals. In 750, parameters relating to the target source may be obtained by calculation according to the fused new received signal. These parameters may include but is not limited to the orientation, the distance, the height, the angle, the slant range, the relative velocity, the DOA of the target source, or the like, or a combination thereof. The parameter estimation method may include the ML algorithm, the APES algorithm, the ESPRIT algorithm, the MUSIC algorithm, the AV algorithm, the Capon algorithm, the GLRT algorithm, or the like, or a combination thereof. After calculation of the parameters, the process is directly returned to 710 to read a new signal or a group of signals again, for example, a new process may start.

The methods and steps described herein may occur in any suitable order in an appropriate situation or may be performed simultaneously. In addition, an individual step may be omitted from any of the methods without departing from the spirit and scope of the subject matter described herein. Each aspect of any of the examples described above may be combined with various aspects of any of the other examples described to form a further example without losing the sought effects. For example, a corresponding storage steps (not shown) may be added between any two steps in the process, and be used for storing intermediate data or other data involved in the signal analysis process. The 730 is not necessary, if the processing of the signal when the signal is transmitted is sufficiently detailed, or the processing conditions that the transmitter may select are sufficient, for example, if the number and expression of the received signal are sufficient to satisfy the preset accuracy of the system, the process of expanding the virtual received signal is not necessary.

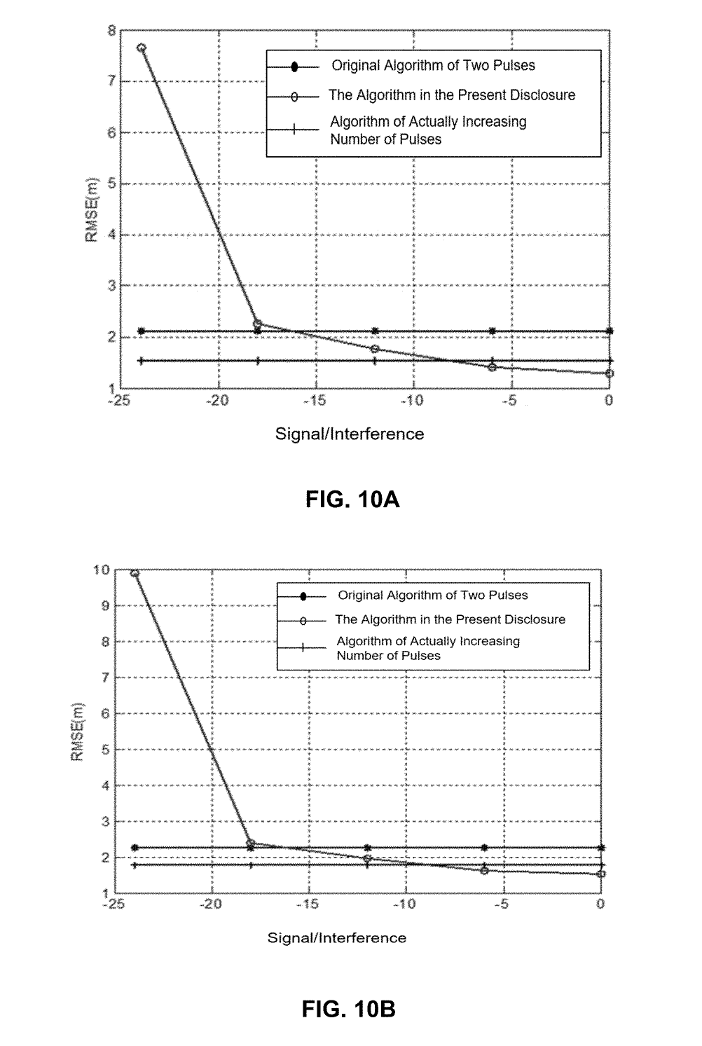

FIG. 8 is a schematic diagram of a process for transmitting and receiving a signal by the system of radar communication according to the present disclosure. As shown in the figure, an original signal is x(t), if the transmitter 110 transmits a signal, there may be n optional carrier frequency values such as f₁, f₂, . . . , fₖ, . . . , fₙ. Wherein, the carrier frequency fₖ may indicate that there is interference under the current carrier. The transmitter may also have various other optional processing conditions, may refer to description of the transmitter 110 in any part of the specification. The transmitter 110 may select one, one set of or multiple carrier frequencies from the n carrier frequency values to process the original signal x(t) by adding a carrier. The signal after the processing by adding a carrier may be transmitted through the transmitting antenna 130T. The transmitted signal may be reflected by the target source, and then received by the receiving antenna 130R and transmitted to the receiver 120. xⱼ(t) may represent a signal that is the transmitted signal reflected and delayed by the j^{th} target, the received signal may be expressed as x₁(t), x₂(t), . . . , xₙ(t), respectively.

If there are a transmit signals and m target sources, the carrier frequencies of the transmitter are f₁, f₂, . . . , fₙ, the received signal may be expressed as:

$$y ( t ) = [ \begin{matrix}{γ}_{11} & ⋯ & {γ}_{1 m} \\ ⋮ & ⋱ & ⋮ \\ {γ}_{n 1} & ⋯ & {γ}_{nm}\end{matrix} ] \cdot [ \begin{matrix}{x}_{11} ( t ) & ⋯ & {x}_{1 a} ( t ) \\ ⋮ & ⋱ & ⋮ \\ {x}_{m 1} ( t ) & ⋯ & {x}_{ma} ( t )\end{matrix} ] \qquad ( 1 )$$

wherein, γᵢⱼ represents the channel coefficient in which the transmitted signal with a carrier frequency fᵢ is reflected and delayed by the target j, and xᵢⱼ(t) is a portion of the received signal after the i^{th} transmitted signal is reflected and delayed by the target source j.

The receiving link 310 in the receiver 120 may perform a series of operations such as preprocessing, filtering processing, frequency conversion, frequency synthesis, and amplification on the received signal. The detection module 320 may detect whether there is interference for the received signal of each carrier frequency, and if so, the carrier frequency is omitted and a portion of the received signal corresponding to the carrier frequency may not participate in the subsequent calculation, for example, the received signal of the carrier frequency fₖ may not participate in the subsequent calculation. The analysis module 330 may further process the received signal, as described elsewhere in the specification regarding the analysis module 330, and further may calculate the parameters of the target source according to the processing results. These parameters may include but is not limited to the orientation, the distance, the height, the angle, the slant range, the relative velocity, the DOA, or the like, or a combination thereof.

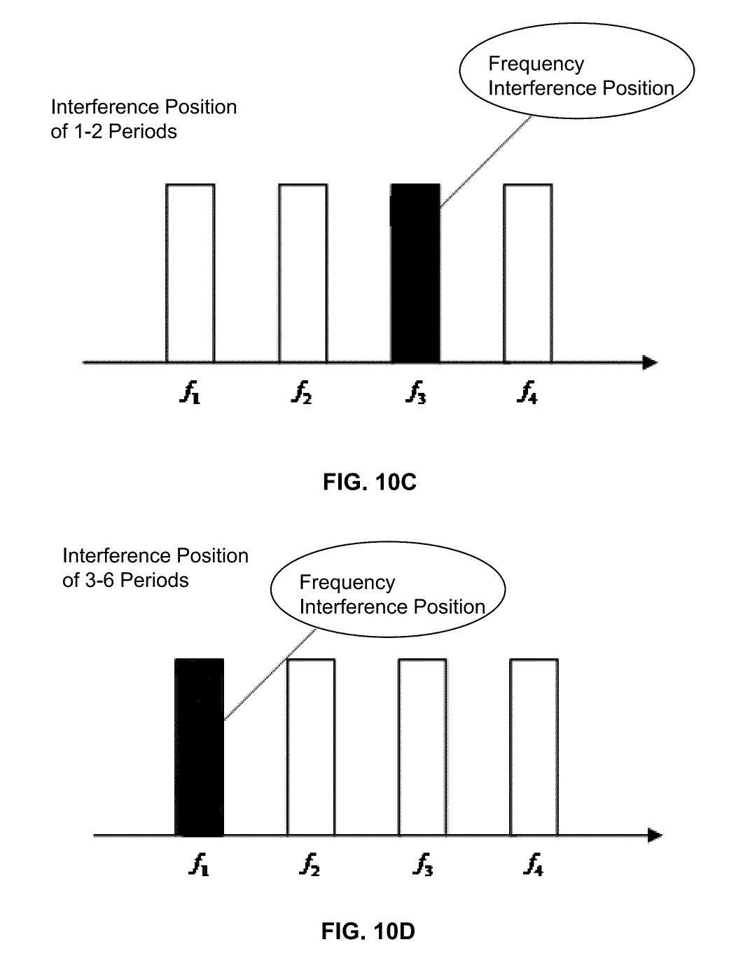

FIG. 9 is a flowchart of a specific embodiment of the system of radar communication. The embodiment will be described using a system having a transmitted signal, two available carrier frequencies, and two target sources as an example. However, the process and calculation, analysis, or processing methods involved in the flowchart are applicable to a plurality of signals, a plurality of carrier frequencies, and a plurality of target sources.

The operation process of the embodiment may include the following steps: first, an original signal is read in 910, and the signal may be read from the signal source 240 or may be read from the external device 150. Judgment step 920 may be performed to determine whether or not to select a carrier frequency while the signal is read. Otherwise, 920 is performed after the signal is read, the two may not have a clear order. The frequency selection step 920 may be performed by the selection module 220. The module 220 may detect the frequency under no interference from a plurality of frequencies to be selected at a fixed time interval using a conventional spectrum sensing technique (930) and save the frequency under no interference in the selection module 220 or save the frequency under no interference in any of the storage modules (not shown) or storage units (not shown) in the system. The operation process of the spectrum sensing technique may include the following steps: first, dividing the broadband into sub-bands, then detecting whether there is interference in each sub-band by using a spectrum sensing algorithm based on the feature value, and selecting the frequency under no interference as a carrier frequency of a transmitted waveform. It is also possible to complete detection by a multi-scale wavelet transform method, that is: first, locating an edge of a band under interference on a spectrum, and then determining whether a frequency point to be transmitted falls within the frequency band under interference, and selecting a frequency point under no interference therefrom as a carrier frequency of the transmitted signal. The available carrier frequency (carrier frequency under no interference) may be selected through the spectrum sensing algorithm and saved in the selection module 220. The transmission link 230 may read a carrier frequency under no interference, process the original signal by adding a carrier, and transmit the signal. The operation process may ensure that the transmitted signal may not fall within the frequency band under interference, thus preliminarily ensuring that transmitted waveform of the radar system may be not subject to interference.

In the embodiment, two frequencies f1 and f2 under no interference may be selected as the carrier frequencies, and the read signal may be processed by adding a carrier in 940. If the frequency selection operation is not performed in 920, two frequencies may be randomly read from the frequencies existing in the system as the carrier frequencies, or a frequency point existing in the system or a system default frequency point may all be used as the carrier frequencies. Then 940 may be performed, the read signal may be processed by adding a carrier. 940 of processing by adding a carrier may be performed by the transmission link 230. After processing by adding a carrier, signal transmission may be performed in 950, the step may be performed by the transmitting antenna 130T. In the embodiment, a radar model of step frequency may be selected to perform the signal transmission. The step frequency source may implement a step-by-step growth in the frequency between signal pulses and pulses, and front ends of a transmitter and a receiver should be broadband to adapt changes in frequency of the transmitted signal and frequency of the received signal frequency. At the transmitter, a coherent oscillator and a frequency synthesizer may be added to a mixer, and the sum of the two frequencies may be converted to a radio frequency through a stable local oscillation circuit, the finally synthesized signal may be composed of three signals relating to the local oscillator, the coherent oscillator, and the frequency synthesizer, and then amplified and transmitted.

The transmitted signal may arrive at the target source 140, and may be reflected through the target source, and a reflected signal may be returned. The reflected signal may be received by the receiving antenna 130R and transmitted to the receiver 120 (960). After the reflected signal is received, preprocessing may be performed in 970. The preprocessing step 970 may be performed through the receiving link 310. In the embodiment, the preprocessing process may include but is not limited to noise removal, interference removal, signal amplification, or the like. After the received signal is preprocessed, filtering may be performed in 980. The purpose of filtering operation may be to detect possible interference frequency point in the received signal. The filtering step 980 may be performed by the receiving link 310 or the detection module 320. It should be noted that the preprocessing step 970 and the filtering step 980 may be combined into a same step, and not necessarily and separately performed. It should also be noted that, after the filtering step 980, there may be a frequency conversion and a frequency synthesis step (not shown), the specific operation process may be: first, converting to an intermediate-frequency signal through a local oscillator, and then converting to a baseband signal by a frequency synthesizer. Similarly, the step may also be included in 980 without being performed separately. In the embodiment, the received signal is y(t), including portions of the received signal corresponding to the carrier frequencies f₁ and f₂, respectively. The filtering processing may be: first filtering the portion of the received signal whose carrier frequency is f₁ to obtain a filtered signal as y₁(t); then, filtering the portion of the received signal whose carrier frequency is f₂ to obtain a filtered signal as y₂(t).

After the filtering processing is completed, 990 may be performed to calculate a correlation between the two filtered signals y₁(t) and y₂(t) and the transmitted signal. In the embodiment, the process of calculating the correlation may be: scanning y₁(t) and y₂(t) through the transmitted signal x(t), and calculating the correlation between y₁(t) and the transmitted signal x(t), y₂(t) and the transmitted signal x(t) respectively. The correlation coefficients are denoted as ρ₁ and ρ₂, respectively. Then, 9100 may be performed to judge whether or not the calculated correlation coefficients ρ₁ and ρ₂ satisfy a preset threshold judgment condition. If the judged result is that the calculated correlation coefficients ρ₁ and ρ₂ are greater than the threshold value, it is judged that the portion of the received signal corresponding to the carrier frequency is under little interference and the carrier frequency may be determined as the frequency of the desired signal (9110); if the judged result is that the calculated correlation coefficients ρ₁ and ρ₂ are less than the threshold value, it is judged that there is interference, and the carrier frequency is omitted (9120). The interference detection process may be performed cyclically until all frequency points have been detected. The interference detection process may be performed by the detection module 320.

In a specific embodiment, assuming that the transmitted waveform is a narrowband signal, the target moves relatively slow, then delay due to the target received in the received signals are the same, x₁(t) represents a signal that is the transmitted signal reflected and delayed by the j^{th} target, γᵢⱼ represents the channel coefficient in which a signal whose carrier frequency is fᵢ is reflected and delayed through the j^{th} target, and the reflection coefficients of all the target sources are equal, so the received signal may be simplified as:

y(t)=γ₁₁·x₁(t)+γ₂₁·x₁(t)+γ₁₂·x₂(t)+γ₂₂·x₂(t)+n(t), (2)

wherein, n(t) is a noise signal.

The channel coefficient may be recovered in 9130, herein, the recovery of γ₁₁ may be taken as an example.

For the received signal whose carrier frequency is f₁, a signal filtered and removed a carrier by a transmitter aligned with a filter of fi is:

y₁(t)=γ₁₁·x₁(t)+y₁₂·x₂(t)+n(t) (3)

The y₁ (t) may be scanned by the transmitted signal x(t), the delay τⱼ for each target may be estimated, and thus the estimated value \hat{x}ⱼ(t)=xⱼ(t)+\tilde{x}ⱼ(t) of reflected signal xⱼ(t) of the j^{th} target may be established, wherein, \tilde{x}ⱼ(t) represents an estimation error, and \hat{γ}₁₁ may be obtained as:

$${\hat{γ}}_{11} = \frac{1}{T \vert \vert {x}_{1} ( t ) {\vert \vert}^{2}} {\int }_{0}^{T} {\hat{x}}_{1}^{*} ( t ) \cdot {y}_{1} ( t ) dt = {γ}_{11} + {\tilde{γ}}_{11} \qquad ( 4 )$$

wherein, γ₁₁ is a real value, \tilde{γ}ₙ is an error generated in the recovery process. From the correlation of the waveform, \tilde{γ}₁₁ is a small value, and may be ignored. Similarly, \tilde{γ}₁₂ may be recovered and \hat{γ}₂₁ and \hat{γ}₂₂ may be recovered according to y₂ (t) and \hat{x}₂(t).

After obtaining the channel coefficients of the portions of the received signal corresponding to the frequencies f₁ and f₂, 9140 may be performed, and the virtual carrier frequencies may be expanded according to f₁ and f₂. In the embodiment, the third and fourth carrier frequencies may be expanded, and may be 2f₁−f₂ and 2f₂−f₁, respectively. Further, it is possible to generate portions of the virtual received signal corresponding to the carrier frequencies of 2f₁−f₂ and 2f₂−f₁, respectively (9150), and the corresponding portions of the virtual received signal may be y′₁ (t) and y′₂(t).

y′₁(t)=\hat{γ}₁₁·\hat{γ}₁₁·\hat{γ}*₂₁·x₁(t)+\hat{γ}₁₂·\hat{γ}₁₂·\hat{γ}*₂₂·x₂(t) (5)

y′₂(t)=\hat{γ}₁₁·\hat{γ}₂₁·\hat{γ}*₂₁·x₁(t)+\hat{γ}₁₂·\hat{γ}₂₂·\hat{γ}*₂₂·x₂(t) (6)

The portions of the received signal may be fused to a received signal in 9160, according to a received signal that has been received and a virtual received signal that has been virtually expanded. Preferably, the fused received signal may be a linear combination of the original received signal y(t) and the virtual received signals y′₁(t) and y′₂(t). The fusion step 9160 may be performed by the fusion center 630. Finally, in 9170, the parameters of the target source may be calculated according to the fused received signal, and may include but is not limited to the orientation, the distance, the height, the angle, the slant range, the relative velocity, the DOA, or the like, or a combination thereof. The parameters of the target source obtained by calculation may be saved in the system, or may be transmitted to the external device 150. The parameters may be stored in the external device 150, or may be displayed through the external device 150.

In the embodiment, the frequencies of the virtually expanded virtual received signals are 2f₁−f₂ and 2f₂−f₁, but it may not indicate that the system of radar communication may only process the case where the virtual carrier frequencies are 2f₁−f₂ and 2f₂−f₁. Specifically, the system of radar communication may process the situation in which a virtual carrier frequency is |nf₁−mf₂|, wherein, n and m are positive integers greater than or equal to one. Preferably, the positive integer m, n should satisfy |n−m|=1.

In the embodiment, we have described the number of carrier frequencies as two, but it may not indicate that the system of radar communication may only process the case where there are two carrier frequencies. The system may be applied to any number of transmitted signals with two or more carrier frequencies. For example, but not limited to, when the number of carrier frequencies is an even number such as four, six, eight, the frequency expansion may be performed by a group of two carrier frequencies, and when the number of carrier frequencies of the transmitted signal is an odd number such as three, five and seven, two, four and six pulses may be selected therefrom respectively, and then the frequency expansion may be performed by a group of two carrier frequencies. When the virtual expansion is performed, expansion may continue according to the signal features obtained by the virtual expansion.

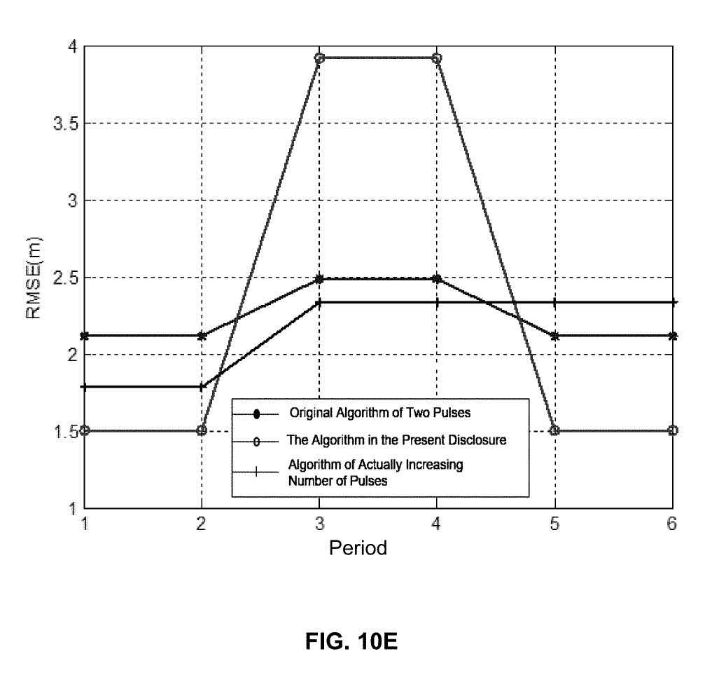

FIGS. 10A to 10E are views showing experimental results for a specific embodiment of the system of radar communication. The figures may vividly show the experimental results of the system for calculating a distance of a target source. FIGS. 10A and 10B are schematic diagrams of change of Root Mean Square Error (RMSE) with Signal/Interference under conditions that the algorithm according to the disclosure has fixed frequency interference, the number of sampling points L=2̂9, Signal Noise Ratio(SNR)=15 dB, correlation coefficient of the transmitted signal and the interference signal u=0.1, judgment threshold ε=0.98 and the number of target sources is six; and FIGS. 10C and 10D are schematic diagrams of the frequency interference provided by the present disclosure hopped from f₃ to f₁.

As can be seen from FIGS. 10A and 10B, since an algorithm of actually transmitting four pulses may include an influence affected by the frequency interference, the performance is affected by the frequency interference, and the more serious the frequency interference, the worse the performance. However, the performance of the algorithm of the present disclosure may be always excellent. As can be seen from FIGS. 10C, 10D and 10E, from a hopping view of the frequency interference and a change view of RMSE with dynamic frequency interference, it can be seen that, in the one and two periods, since there is no interference in the vicinity of the carrier frequencies f₁ and f₂ of two actually transmitted pulse signals, the algorithm involved in the present disclosure may perform virtual expansion by using the received signal under no interference, according to the analysis, it is found that the algorithm of the present disclosure has better performance; in three and four periods, since the frequency interference may hop from f₃ to f₁, the performances of the algorithm of two pulses, the algorithm of actually increasing number of pulses and the algorithm of the present disclosure deteriorate to some extent. In the fifth period, the transmitter may dynamically adjust the carrier frequency of the transmitted signal, so that in five and six periods, the performance of the algorithm of two pulses and the algorithm of the present disclosure may recover to the previous good performance, and the performance of the algorithm of actually increasing number of pulses is poor.

It should be noted that, the steps described in the specification, the operation processes, the functions of modules or units, or the like may be performed as described in the specification, or some steps or some module s or units may be omitted in some situations. Similarly, the situations described herein is not necessary to implement the advantages of the embodiments described herein, but is provided merely for convenience of presentation, expression, description and illustration. It will be apparent to persons with ordinary skilled in the art that some steps may be added or omitted, some modules or units may be added or omitted, or some steps may be repeatedly performed, or some modules or units may be reused, depending on the requirements.

It is also should be understood that the structures and configurations disclosed herein are exemplary in nature and are provided merely for illustration, and these specific embodiments are not limiting, and various variations may be made by persons with ordinary skill in the art depending on different requirements. In addition, the subject matter disclosed herein includes all novel and non-obvious combinations and sub-combinations of various structures and configurations disclosed herein, as well as other factures, functions, and/or attributes.

1-3. (canceled)

4. A method for parameter estimation in a radar system, comprising:
receiving signals reflected from a target source;
filtering the received signals using a filter corresponding to a carrier signal;
converting the filtered signal downward to a baseband signal using a corresponding carrier frequency;
detecting whether or not the received signals relating to each frequency band are under interference;
generating first received signals under no interference by omitting received signals under interference from the received signals;
generating second received signals by expanding the first received signals virtually;
determining fused received signals by fusing the first received signals under no interference and the second received signals; and
estimating a parameter relating to the target source based on the fused received signals.

5. The method for parameter estimation of claim 4, wherein the detecting whether or not the received signals relating to each frequency band are under interference is determined by respectively detecting a correlation parameter between the received signals relating to each frequency band and the corresponding transmitting signals.

6. The method for parameter estimation of claim 5, wherein the received signal is under no interference when the correlation parameter is larger than a threshold.

7. The method for parameter estimation of claim 4, wherein the generating the second received signals by expanding the first received signals virtually is performed based on received signals corresponding to two or more different carrier frequencies.

8. The method for parameter estimation of claim 7, wherein the the carrier frequencies of the generated second received signals are linear combination of the carrier frequencies.

9. The method for parameter estimation of claim 4, wherein the determining fused received signals by fusing the first received signals under no interference and the second received signals is performed by linearly combining the first received signals under no interference and the second received signals.

10. The method for parameter estimation of claim 4, wherein the characteristics lies in that the parameter relating to the target source comprises distance, height, DOA, and relative velocity.

11. The method for parameter estimation of claim 4, wherein the characteristics lies in that the method for parameter estimation includes ML algorithm, APES algorithm, ESPRIT algorithm, MUSIC algorithm, AV algorithm, Capon algorithm, and GLRT algorithm.

12. A radar system, comprising:
a receiver, receiving a transmitting signal from a signal source;
selection module, detecting a frequency band under little interference or no interference from a plurality of carrier frequencies to be selected; and
a transmitting link, generating a carrier signal based on the detected frequency band and modulating and transmitting the transmitting signal using the carrier signal.

13. The system of claim 12, wherein the characteristics lies in that the transmitting signal is of Gaussian sequences, polyphase code, or space-time code.

14. The system of claim 12, wherein the characteristics lies in that the detecting the frequency band under little interference or no interference is performed via a method of spectrum sensing based on energy detection or feature detection.

15. A radar system, comprising:
a receiver, receiving signals reflected from a target source;
a receiving link, filtering the received signals using a filter corresponding to a carrier signal and converting the filtered signal downward to a baseband signal using a corresponding carrier frequency;
a detection module, detecting whether or not the received signals relating to each frequency band are under interference and generating first received signals under no interference by omitting received signals under interference from the received signals;
an expanding unit, generating second received signals by expanding the first received signals virtually;
a fusion center, determining fused received signals by fusing the first received signals under no interference and the second received signals; and
a calculation module, estimating a parameter relating to the target source based on the fused received signals.

16. The system of claim 15, wherein the detecting whether or not the received signals relating to each frequency band are under interference is determined by respectively detecting a correlation parameter between the received signals relating to each frequency band and the corresponding transmitting signals.

17. The system of claim 16, wherein the received signal is under no interference when the correlation parameter is larger than a threshold.

18. The system of claim 15, wherein the generating the second received signals by expanding the first received signals virtually is performed based on received signals corresponding to two or more different carrier frequencies.

19. The system of claim 15, wherein the carrier frequencies of the generated second received signals are linear combination of the carrier frequencies.

20. The system of claim 15, wherein the determining fused received signals by fusing the first received signals under no interference and the second received signals is performed by linearly combining the first received signals under no interference and the second received signals.

21. The system of claim 15, wherein the characteristics lies in that the parameter relating to the target source comprises distance, height, DOA, and relative velocity.

22. The system of claim 15, wherein the characteristics lies in that the method for parameter estimation includes ML algorithm, APES algorithm, ESPRIT algorithm, MUSIC algorithm, AV algorithm, Capon algorithm, and GLRT algorithm.
